(19) United States
(12) Patent Application Publication
(10) Pub. No.: US 2025/0239950 A1
(43) Pub. Date: Jul. 24, 2025

(54) MOTOR DRIVE DEVICE AND MOTOR DRIVE METHOD

(71) Applicant: Nuvoton Technology Corporation Japan, Kyoto (JP)

(72) Inventors: Daisuke FUKUDA, Kyoto (JP); Shinnosuke SAKAMOTO, Kyoto (JP); Takuya ISHII, Osaka (JP)

(21) Appl. No.: 19/172,033

(22) Filed: Apr. 7, 2025

Related U.S. Application Data
(63) Continuation of application No. PCT/JP2023/035545, filed on Sep. 28, 2023.

(30) Foreign Application Priority Data
Oct. 28, 2022 (JP) 2022-173034

(51) Int. Cl. H02P 1/16; H02P 1/04

(52) U.S. Cl. CPC H02P 1/16; H02P 1/04; H02P 2205/07

(57) ABSTRACT

A motor drive device includes: a target speed generator that generates a target speed signal indicating a target speed of a motor; an actual speed detector that generates an actual speed signal indicating an actual speed; and a driver that drives the motor to cause the actual speed indicated by the actual speed signal to approach the target speed indicated by the target speed signal. The target speed generator (i) generates an input speed signal based on an input command and a tentative speed signal higher than the actual speed signal at startup, and (ii) when the actual speed indicated by the actual speed signal at the startup is higher than a speed indicated by the input speed signal, outputs the tentative speed signal as the target speed signal.

### CROSS REFERENCE TO RELATED APPLICATIONS

This is a continuation application of PCT International Application No. PCT/JP2023/035545 filed on Sep. 28, 2023, designating the United States of America, which is based on and claims priority of Japanese Patent Application No. 2022-173034 filed on Oct. 28, 2022. The entire disclosures of the above-identified applications, including the specifications, drawings and claims are incorporated herein by reference in their entirety.

### FIELD

The present disclosure relates to a motor drive device and a motor drive method, and particularly relates to a drive method for driving a motor upon startup.

### BACKGROUND

A drive device of a fan motor detects rotational frequency of the motor, and increases or decreases the torque so as to achieve the target rotation frequency to adjust the air volume of the fan. Before startup of the fan motor, the fan motor is typically at a standstill or in a low-speed rotation state in which the fan motor is coasting after being stopped. Then, after the fan motor is started, the fan motor increases the torque toward the target rotational frequency. However, when the fan is running at idle due to external force such as the wind, and particularly when the fan motor is running in reverse rotation at idle, the load on the fan motor increases, causing startup of the fan motor difficult. Note that the reverse rotation is rotation in the opposite direction of the rotation direction (i.e., forward rotation) in which the motor is to be driven. Patent Literature (PTL) 1 and PTL 2 disclose methods of starting a fan motor in forward rotation even though the fan is running in reverse rotation before startup of the fan motor.

### CITATION LIST

### Patent Literature

PTL 1: Japanese Unexamined Patent Application Publication No. H07-337080

PTL 2: Japanese Unexamined Patent Application Publication No. 2005-137106

### SUMMARY

### Technical Problem

All of conventional techniques like the above-described PTL 1 and PTL 2 detect, at startup, the rotation direction in which a fan motor runs at idle in addition to detection of the rotor position and rotational frequency, and select a drive method depending on whether the rotation in which the fan motor runs at idle is forward rotation or reverse rotation. This complicates the driving circuit. Meanwhile, when a fan motor is merely driven toward the target rotational frequency without detecting the rotation direction, the motor will run out of control when the rotational frequency is greater than or equal to the target value, and the rotation state will be maintained in accordance with the external force.

In view of the above, the present disclosure proposes a motor drive device and a motor drive method which are capable of reliably starting a motor toward target rotational frequency in forward rotation with a simple configuration.

### Solution to Problem

In view of the above, a motor drive device according to one embodiment of the present disclosure includes: an actual speed detector that generates an actual speed signal indicating an actual speed of a motor; a target speed generator that generates a target speed signal indicating a target speed of the motor; and a driver that drives the motor to cause the actual speed indicated by the actual speed signal to approach the target speed indicated by the target speed signal. The target speed generator (i) generates a first target speed signal indicating a speed based on an input command and a second target speed signal indicating a speed higher than the actual speed at startup of the motor drive device, and (ii) when the actual speed indicated by the actual speed signal at the startup of the motor drive device is higher than the speed indicated by the first target speed signal, outputs the second target speed signal as the target speed signal.

Moreover, a motor drive method according to one embodiment of the present disclosure is a motor drive method used by a motor drive device. The motor drive method includes: generating an actual speed signal indicating an actual speed of a motor; generating a target speed signal indicating a target speed of the motor; and driving the motor to cause the actual speed indicated by the actual speed signal to approach the target speed indicated by the target speed signal. In the generating of the target speed signal, (i) a first target speed signal indicating a speed based on an input command and a second target speed signal indicating a speed higher than the actual speed at startup of the motor drive device are generated, and (ii) when the actual speed indicated by the actual speed signal at the startup of the motor drive device is higher than the speed indicated by the first target speed signal, the second target speed signal is output as the target speed signal.

### Advantageous Effects

Accordingly, the present disclosure can realize a motor drive device and a motor drive method which are capable of reliably starting a motor toward target rotational frequency in forward rotation with a simple configuration.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a circuit diagram illustrating a motor drive device according to Embodiment 1.

FIG. 2 illustrates a timing diagram (part (a) of FIG. 2) showing normal startup of the motor drive device according to Embodiment 1, a timing diagram (part (b) of FIG. 2) showing startup from an idling state in which the motor drive device runs in forward rotation at a high speed, and a timing diagram (part (c) of FIG. 2) showing startup from an idling state in which the motor drive device runs in reverse rotation at a high speed.

FIG. 3 is a circuit diagram illustrating a motor drive device according to Embodiment 2.

FIG. 4 illustrates a timing diagram (part (a) of FIG. 4) showing normal startup of the motor drive device according to Embodiment 2, a timing diagram (part (b) of FIG. 4) showing startup from an idling state in which the motor drive device runs in forward rotation at a high speed, and a timing diagram (part (c) of FIG. 4) showing startup from an idling state in which the motor drive device runs in reverse rotation at a high speed.

FIG. 5 is a circuit diagram illustrating a motor drive device according to Embodiment 3.

FIG. 6 illustrates a timing diagram (part (a) of FIG. 6) showing normal startup of the motor drive device according to Embodiment 3, a timing diagram (part (b) of FIG. 6) showing startup from an idling state in which the motor drive device runs in forward rotation at a high speed, and a timing diagram (part (c) of FIG. 6) showing startup from an idling state in which the motor drive device runs in reverse rotation at a high speed.

FIG. 7 is a flowchart illustrating operation (i.e., a motor drive method) performed by the motor drive device according to Embodiments 1 to 3.

### DESCRIPTION OF EMBODIMENTS

Hereinafter, embodiments according to the present disclosure will be described with reference to the drawings. Note that the embodiments described below each show a specific example of the present disclosure. The numerical values, shapes, materials, elements, the arrangement and connection of the elements, etc., in the following embodiments are mere examples, and therefore do not intend to limit the present disclosure.

Throughout the drawings, the same reference mark is given to substantially the same element, and redundant descriptions may be omitted or simplified. The expression “A and B are connected” means A and B are electrically connected, and includes not only the case where A and B are directly connected but also the case where A and B are indirectly connected with another circuit element interposed therebetween. Moreover, in descriptions of the magnitude of “signals”, the “signals” indicate “values indicated by the signals”.

### Embodiment 1

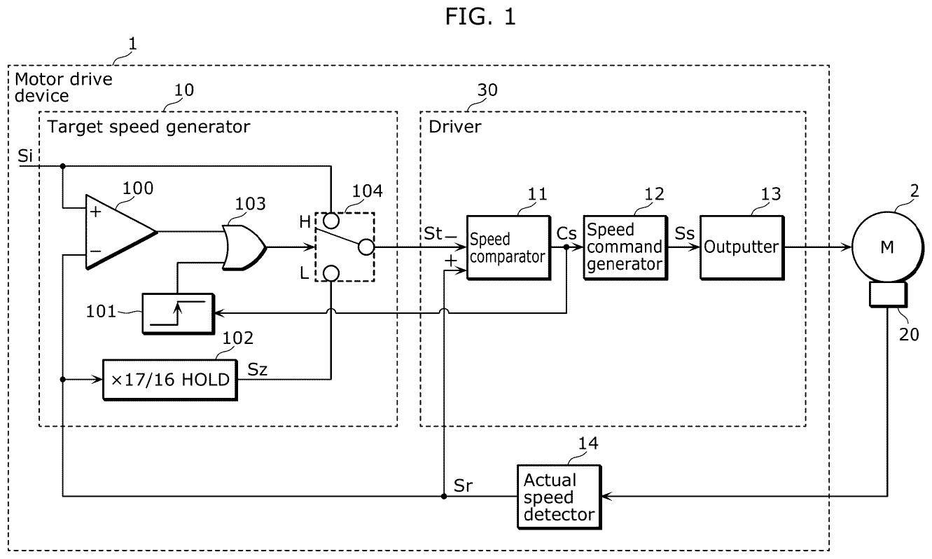

FIG. 1 is a circuit diagram illustrating motor drive device 1 according to Embodiment 1 of the present disclosure. In FIG. 1, motor drive device 1 is, for example, a drive device of a fan motor, and includes target speed generator 10, driver 30 (speed comparator 11, speed command generator 12, and outputter 13), and actual speed detector 14. In accordance with input speed signal Si indicating target rotational frequency of motor 2, motor drive device 1 drives at a high speed to cause motor 2 to run in forward rotation when the rotational frequency of motor 2 is lower than the target rotational frequency. In this way, motor drive device 1 drives motor 2 such that that the rotational frequency of motor 2 follows the target rotational frequency. Input speed signal Si is an input command signal from an external device (e.g., microcomputer) which has been converted such that the signal can be processed inside motor drive device 1.

Motor 2 is provided with location sensor 20 such as a hall element, and rotor location information of motor 2 which is issued from location sensor 20 is input to actual speed detector 14 of motor drive device 1. Actual speed detector 14 calculates the rotational frequency of motor 2 from the rotor location information, and outputs actual speed signal Sr.

Target speed generator 10 receives inputs of input speed signal Si and actual speed signal Sr, and outputs target speed signal St. Input speed signal Si is one example of a first target speed signal that indicates a speed based on an input command. Actual speed signal Sr is a signal that indicates the actual speed of motor 2. Target speed signal St is a signal that indicates a target speed of motor 2. In the case of normal startup in which actual speed signal Sr is less than input speed signal Si, input speed signal Si is output from target speed generator 10 as the target speed signal, and when actual speed signal Sr is greater than input speed signal Si, a signal greater than actual speed signal Sr (e.g., a signal increased by 6.25% of actual speed signal Sr) is output from target speed generator 10 as target speed signal St. In other words, target speed generator 10 has a feature of (i) generating a first target speed signal indicating a speed based on an input command and a second target speed signal indicating a speed higher than the actual speed at startup of motor drive device 1, and (ii) when the actual speed indicated by the actual speed signal at the startup of motor drive device 1 is higher than the speed indicated by the first target speed signal, outputting the second target speed signal as the target speed signal.

It should be noted that, as described above, each of input speed signal Si, actual speed signal Sr, and target speed signal St is a signal corresponding to rotational frequency of a motor (rotational frequency as the absolute value, irrespective of forward rotation or reverse rotation). Accordingly, the magnitude of signals, which is indicated as great or less (high or low), indicates a high or low rotational frequency. Moreover, each signal may be a digital signal or an analog signal, or may even be a pulse-width modulation signal indicating the magnitude of a signal by a duty ratio, but, in the description of the present disclosure, each signal is indicated as an analog signal (a positive voltage) such that the rotational frequency is readily imagined.

In other words, a speed means a rotational speed, and is synonymous with rotational frequency. The rotational frequency is rotational frequency of motor 2 per unit time. The terms “great” and “high” applied to input speed signal Si, actual speed signal Sr, and target speed signal St mean the speed and/or rotational frequency of motor 2 indicated by these signals are great and/or high.

Driver 30 includes speed comparator 11, speed command generator 12, and outputter 13.

Speed comparator 11 compares target speed signal St with actual speed signal Sr, and outputs speed comparison result Cs. Speed comparison result Cs may be a signal indicating a speed error, but in the present disclosure, speed comparison result Cs indicates H level when actual speed signal Sr is higher than or equal to target speed signal St and L level when actual speed signal Sr is lower than target speed signal St, for the purpose of simplifying the description.

Speed command generator 12 receives an input of speed comparison result Cs from speed comparator 11, and outputs speed command signal Ss. For example, when actual speed signal Sr is lower than target speed signal St (i.e., when speed comparison result Cs indicates L level), speed command signal Ss increases, and when actual speed signal Sr is higher than or equal to target speed signal St (i.e., when speed comparison result Cs indicates H level), speed command signal Ss decreases. Feedback of speed comparison result Cs is provided to also be input to target speed generator 10. When actual speed signal Sr reaches target speed signal St and is changed to indicate H level, target speed generator 10 changes the increased target speed signal St back to input speed signal Si as the signal to be output as target speed signal St.

Outputter 13 outputs, for example, a pulse-width modulation signal having a duty ratio in accordance with speed command signal Ss to drive motor 2.

Target speed generator 10 includes comparator circuit 100, edge detection circuit 101, tentative speed setting circuit 102, OR circuit 103, and switching circuit 104. In comparator circuit 100, input speed signal Si is compared with actual speed signal Sr, and a signal indicating H level is output when input speed signal Si is greater than actual speed signal Sr. Edge detection circuit 101 receives an input of speed comparison result Cs from speed comparator 11. Edge detection circuit 101 outputs L level at startup, and outputs H level when speed comparison result Cs is changed to indicate from L level to H level. Thereafter, edge detection circuit 101 invariably output H level during operation. Tentative speed setting circuit 102 receives an input of actual speed signal Sr from actual speed detector 14, and outputs a signal greater than actual speed signal Sr (e.g., 17/16 times actual speed signal Sr, that is, an increase of 6.25%) as tentative speed signal Sz. Tentative speed signal Sz is one example of a second target speed signal indicating a speed higher than the actual speed at startup of motor drive device 1. Tentative speed signal Sz output at startup is held and maintained even though actual speed signal Sr changes thereafter. The time period during which tentative speed signal Sz is maintained includes a time period during which at least switching circuit 104 is selecting tentative speed signal Sz as target speed signal St. Switching circuit 104 will be described later in the embodiment. OR circuit 103 outputs, as a switching signal, the logical sum of an output of comparator circuit 100 and an output of edge detection circuit 101. Switching circuit 104 selects and outputs input speed signal Si as target speed signal St when the switching signal output by OR circuit 103 indicates H level, and selects and outputs tentative speed signal Sz as target speed signal St when the switching signal indicates L level.

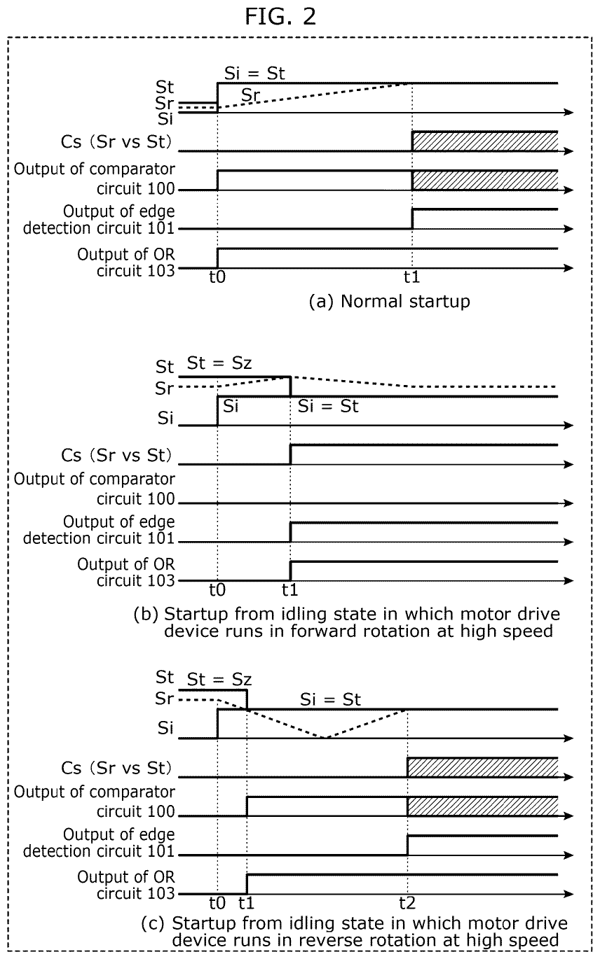

Operation at startup of motor drive device 1 according to Embodiment 1 which is configured as described above will be further described in detail with reference to FIG. 2. FIG. 2 illustrates a timing diagram (part (a) of FIG. 2) showing normal startup of motor drive device 1 according to Embodiment 1, a timing diagram (part (b) of FIG. 2) showing startup from an idling state in which motor drive device 1 runs in forward rotation at a high speed, and a timing diagram (part (c) of FIG. 2) showing startup from an idling state in which motor drive device 1 runs in reverse rotation at a high speed. FIG. 2 shows signal waveforms in main elements of motor drive device 1.

Part (a) of FIG. 2 is a timing diagram showing normal startup, i.e., the case where actual speed signal Sr is lower than input speed signal Si regardless of the rotation direction in an idling state of motor drive device 1 at startup. Although a supply voltage is applied to motor drive device 1 before startup before time t0, input speed signal Si=0, denoting the standby state, and although actual speed signal Sr=0, the output of comparator circuit 100 is set to indicate L level as the initial state. The output of edge detection circuit 101 is also set to indicate L level. Accordingly, the output of OR circuit 103 indicates L level, and thus switching circuit 104 selects and outputs tentative speed signal Sz as target speed signal St. As described above, tentative speed signal Sz is set, by tentative speed setting circuit 102, to increase by 6.25% ( 1/16) of actual speed signal Sr. Here, motor 2 is running in forward rotation at idle due to a slight external force, and the following holds: target speed signal St>actual speed signal Sr>input speed signal Si=0. However, since the standby state involves no speed comparison result Cs, speed command generator 12 and outputter 13 do not drive motor 2.

When a rising edge of input speed signal Si occurs and motor drive device 1 starts at time t0, the following holds: input speed signal Si>actual speed signal Sr. Accordingly, the output of comparator circuit 100 is changed to indicate H level. Switching circuit 104 that has received an input of a switching signal indicating H level via OR circuit 103 selects and outputs input speed signal Si as target speed signal St. In speed comparator 11, the following holds: target speed signal St>actual speed signal Sr. Accordingly, speed comparison result Cs indicates L level, speed command signal Ss from speed command generator 12 that has started operation increases, and the rotational frequency of motor 2 begins to increase in the forward rotation direction (when in the reverse rotation, the rotational frequency begins to increase after a temporary stop). Although the rotational frequency increases and thus actual speed signal Sr increases, target speed signal St, in other words, tentative speed signal Sz is held at the startup and does not change.

When actual speed signal Sr reaches target speed signal St at time t1, speed comparison result Cs indicates H level, and the increase of speed command signal Ss stops. In target speed generator 10, the output of comparator circuit 100 is changed to indicate L level, but the output of edge detection circuit 101 that has detected the transition to H level in speed comparison result Cs is changed to indicate H level. Accordingly, the output of OR circuit 103 is maintained to indicate H level, and switching circuit 104 continues to output input speed signal Si as target speed signal St. Thereafter, the rotational frequency of motor 2 is maintained approximately at the target rotational frequency. Since the rotational frequency of motor 2 slightly exceeds or falls below the target rotational frequency, the output of comparator circuit 100 and speed comparison result Cs are, in a strict sense, unstable (hence, diagonally shaded in the diagram). However, since the output of edge detection circuit 101 is fixed to indicate H level, the switching signal output by OR circuit 103 is also fixed to indicate H level, and switching circuit 104 maintains input speed signal Si as target speed signal St.

Part (b) of FIG. 2 is a timing diagram showing startup from an idling state in which motor drive device 1 runs in forward rotation at a high speed, i.e., the case where the idling state of motor drive device 1 at startup is a state in which motor drive device 1 runs in forward rotation and actual speed signal Sr is higher than input speed signal Si. Except that the level of actual speed signal Sr is high, part (b) of FIG. 2 is the same as part (a) of FIG. 2 showing the normal startup before startup before time t0. Although a rising edge of input speed signal Si occurs and motor drive device 1 starts at time t0, the output of comparator circuit 100 indicates L level since the following holds: actual speed signal Sr>input speed signal Si. Since the output of edge detection circuit 101 also indicates L level, the switching signal output by OR circuit 103 indicates L level. Accordingly, switching circuit 104 selects and outputs tentative speed signal Sz as target speed signal St. Tentative speed signal Sz is set, by tentative speed setting circuit 102, to increase by 6.25% ( 1/16) of actual speed signal Sr. Speed comparison result Cs indicates L level since the following holds: target speed signal St>actual speed signal Sr. Accordingly, speed command signal Ss increases, and thus the rotational frequency of motor 2 begins to increase in the forward rotation direction. In the same manner as has been described with reference to part (a) of FIG. 2, target speed signal St that is tentative speed signal Sz held at the startup does not change.

When actual speed signal Sr reaches target speed signal St at time t1, speed comparison result Cs output by speed comparator 11 indicates H level. Accordingly, the increase of speed command signal Ss output by speed command generator 12 stops. In target speed generator 10, the output of edge detection circuit 101 is inverted to be changed to indicate H level, and thus the switching signal output by OR circuit 103 is also changed to indicate H level. Accordingly, switching circuit 104 changes a signal to be output as target speed signal St to input speed signal Si. At this time, the output of comparator circuit 100 indicates L level since the following holds: actual speed signal Sr>target speed signal St=input speed signal Si. However, target speed signal St output by switching circuit 104 maintains input speed signal Si since the output of edge detection circuit 101 is maintained to indicate H level. Speed command signal Ss decreases since the following holds: actual speed signal Sr>target speed signal St. Accordingly, the rotational frequency of motor 2 is decreased to the rotational frequency caused by external force.

Part (c) of FIG. 2 is a timing diagram showing startup from an idling state in which motor drive device 1 runs in reverse rotation at a high speed, i.e., the case where the idling state of motor drive device 1 at startup is a state in which motor drive device 1 runs in reverse rotation and actual speed signal Sr is higher than input speed signal Si. Before startup before time t0, part (c) of FIG. 2 is the same as part (b) of FIG. 2. When a rising edge of input speed signal Si occurs and motor drive device 1 starts at time t0, the following holds: actual speed signal Sr>input speed signal Si. Accordingly, target speed signal St is tentative speed signal Sz that is higher than actual speed signal Sr. Speed comparison result Cs output by speed comparator 11 indicates L level since the following holds: target speed signal St>actual speed signal Sr. Speed command signal Ss output by speed command generator 12 increases, and thus outputter 13 is driven to increase the rotational frequency of motor 2 in the forward rotation direction. To be more specific, when in the reverse rotation state, the rotational frequency begins to decrease.

When the decreased actual speed signal Sr falls below input speed signal Si at time t1, the output of comparator circuit 100 is inverted to indicate H level, and thus the switching signal output by OR circuit 103 is also changed to indicate H level in target speed generator 10. Accordingly, switching circuit 104 changes a signal to be output as target speed signal St to input speed signal Si. The rotational frequency of motor 2 that decreases due to the reverse rotation becomes zero after a while. Then, the rotation is changed to the forward rotation and the rotational frequency begins to increase.

When actual speed signal Sr reaches target speed signal St at time t2, speed comparison result Cs indicates H level and the output of comparator circuit 100 is changed to indicate L level. Thereafter, the rotational frequency of motor 2 is maintained approximately at the target rotational frequency by the same operation described with reference to part (a) of FIG. 2. Although the output of comparator circuit 100 and speed comparison result Cs are unstable, the output of edge detection circuit 101 is fixed to indicate H level and the switching signal is also fixed to indicate H level. Accordingly, switching circuit 104 maintains input speed signal Si as target speed signal St.

As has been described above, since the target rotational frequency is temporarily set greater than the actual rotational frequency, motor drive device 1 according to Embodiment 1 can forcibly drive motor 2 in the forward rotation direction to start motor 2 even in a state in which motor 2 is running in the reverse rotation at rotational frequency greater than or equal to the target rotational frequency due to external force, etc., before the startup.

### Embodiment 2

The motor drive device according to the present disclosure need not be provided with a detection circuit for detecting rotational directions, and can start from the reverse rotation at rotational frequency greater than or equal to the target rotational frequency. However, the motor drive device according to the present disclosure may detect the rotational direction in a simplified manner. When the target rotational frequency is temporarily increased, the actual rotational frequency increases when a motor drive device is running in the forward direction at idle, whereas the actual rotational frequency decreases when the motor drive device is running in the reverse direction at idle. From the above, the rotational direction can be readily detected. A motor drive device according to Embodiment 2 has a function of readily detecting the rotational direction in which a motor runs at idle at the startup by utilizing the above-described occurrences.

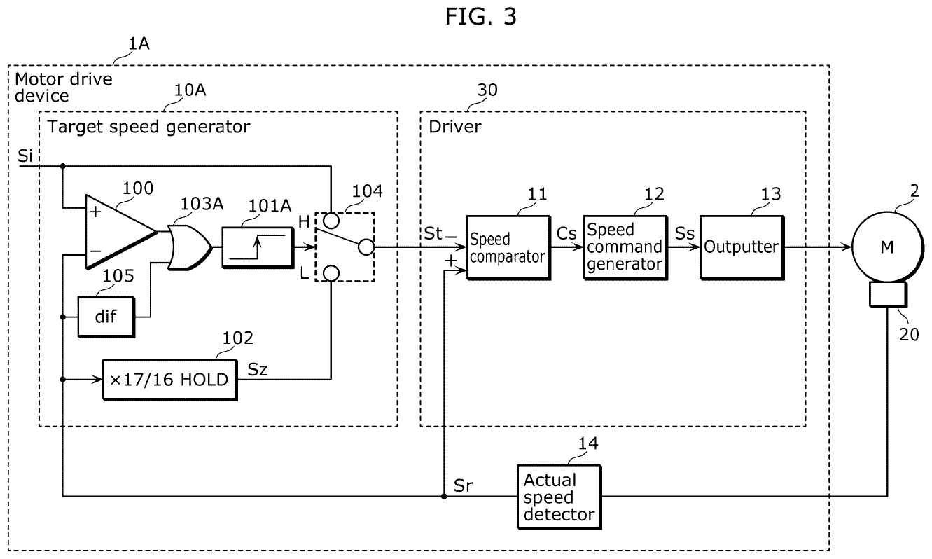

FIG. 3 illustrates a circuit configuration of motor drive device 1A according to Embodiment 2. In FIG. 3, the same numbers are given to the elements same as those included in motor drive device 1 shown in FIG. 1. A difference from FIG. 1 is target speed generator 10A having a modified internal configuration. Specifically, (i) feedback of speed comparison result Cs from speed comparator 11 is not provided, (ii) instead of edge detection circuit 101, edge detection circuit 101A is connected between the output of OR circuit 103A and switching circuit 104, and (iii) differentiator 105 is added. Differentiator 105 detects the slope of actual speed signal Sr to readily detect the rotational direction of motor 2, and outputs H level when actual speed signal Sr is increasing and outputs L level when actual speed signal Sr is decreasing.

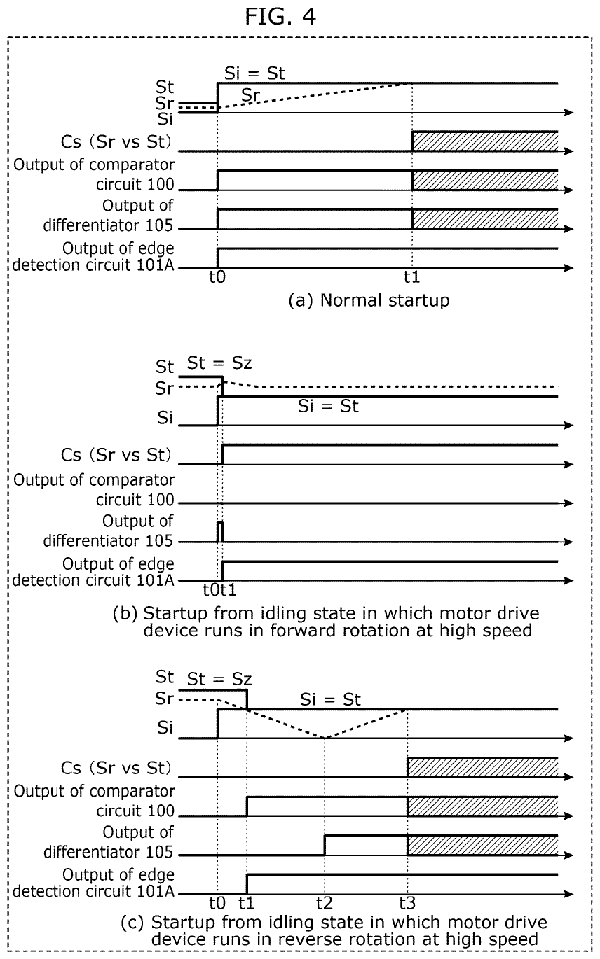

Operation at startup of motor drive device 1A according to Embodiment 2 which is configured as described above will be further described in detail with reference to FIG. 4. FIG. 4 illustrates a timing diagram (part (a) of FIG. 4) showing normal startup of motor drive device 1A according to Embodiment 2, a timing diagram (part (b) of FIG. 4) showing startup from an idling state in which motor drive device 1A runs in forward rotation at a high speed, and a timing diagram (part (c) of FIG. 4) showing startup from an idling state in which motor drive device 1A runs in reverse rotation at a high speed. FIG. 4 shows signal waveforms in main elements of motor drive device 1A.

Part (a) of FIG. 4 is a timing diagram showing normal startup, i.e., the case where actual speed signal Sr is lower than input speed signal Si regardless of the rotation direction in an idling state of motor drive device 1A at startup. Although a supply voltage is applied to motor drive device 1A before startup before time t0, input speed signal Si=0, denoting the standby state, and although actual speed signal Sr=0, the output of comparator circuit 100 is set to indicate L level as the initial state. The output of edge detection circuit 101A and the output of differentiator 105 are also set to indicate L level. Accordingly, the output of OR circuit 103A indicates L level, and switching circuit 104 selects and outputs tentative speed signal Sz as target speed signal St. As described above, tentative speed signal Sz is set, by tentative speed setting circuit 102, to increase by 6.25% ( 1/16) of actual speed signal Sr.

Here, motor 2 is running in forward rotation at idle due to a slight external force, and the following holds true: target speed signal St>actual speed signal Sr>input speed signal Si=0. However, since the standby state involves no speed comparison result Cs, speed command generator 12 and outputter 13 do not drive motor 2.

When a rising edge of input speed signal Si occurs at time t0 and motor drive device 1A starts, the following holds: input speed signal Si>actual speed signal Sr. Accordingly, the output of comparator circuit 100 is changed to indicate H level. The output of OR circuit 103A is also changed to indicate H level, and the output of edge detection circuit 101A, namely, the switching signal input to switching circuit 104, is fixed to indicate H level. Thereafter, switching circuit 104 selects and outputs input speed signal Si as target speed signal St, and the rotational frequency of motor 2 begins to increase in the forward rotation direction (when in the reverse rotation, the rotational frequency increases after a temporary stop). Since actual speed signal Sr increases while the rotational frequency is increasing, the output of differentiator 105 indicates H level. Note that in the same manner as has been described with reference to part (a) of FIG. 2, target speed signal St that is tentative speed signal Sz held at the startup does not change.

After actual speed signal Sr reaches target speed signal St at time t1, the rotational frequency of motor 2 is maintained approximately at the target rotational frequency. Since the rotational frequency of motor 2 slightly exceeds or falls below the target rotational frequency, the output of comparator circuit 100, the output of differentiator 105, and speed comparison result Cs are, in a strict sense, unstable. However, since the output of edge detection circuit 101A, namely the switching signal, is also fixed to indicate H level, switching circuit 104 maintains input speed signal Si as target speed signal St.

Part (b) of FIG. 4 is a timing diagram showing startup from an idling state in which motor drive device 1A runs in forward rotation at a high speed, i.e., the case where the idling state of motor drive device 1A at startup is a state in which motor drive device 1A runs in forward rotation and actual speed signal Sr is higher than input speed signal Si. Except that the level of actual speed signal Sr is high, part (b) of FIG. 4 is the same as part (a) of FIG. 4 showing the normal startup before startup before time t0. When a rising edge of input speed signal Si occurs and motor drive device 1A starts at time t0, the following holds: actual speed signal Sr>input speed signal Si. Accordingly, the output of comparator circuit 100 indicates L level. Since the output of differentiator 105 to which actual speed signal Sr that has not yet changed is input also indicates L level, the switching signal output by OR circuit 103A indicates L level, and the switching signal input via edge detection circuit 101A indicates L level. Accordingly, switching circuit 104 selects and outputs tentative speed signal Sz as target speed signal St. As described in Embodiment 1, tentative speed signal Sz is set, by tentative speed setting circuit 102, to increase by 6.25% ( 1/16) of actual speed signal Sr before the startup. The rotational frequency of motor 2 begins to increase in the forward rotation direction since the following holds: target speed signal St>actual speed signal Sr.

When the output of differentiator 105 that has detected the increase of actual speed signal Sr is changed to indicate H level at time t0, the output of OR circuit 103A is changed to indicate H level, and the output of edge detection circuit 101A, namely the switching signal, is also fixed to indicate H level. Accordingly, switching circuit 104 selects and outputs input speed signal Si as target speed signal St. Since actual speed signal Sr is already higher than target speed signal St that is input speed signal Si, speed comparison result Cs indicates H level. Accordingly, the increase of speed command signal Ss stops, the increased rotational frequency decreases, and actual speed signal Sr is also changed to decrease. In target speed generator 10A, both of the output of comparator circuit 100 and the output of differentiator 105 indicate L level, and thus the output of OR circuit 103A also indicates L level. However, since the output of edge detection circuit 101A is maintained to indicate H level, input speed signal Si is maintained as target speed signal St output by switching circuit 104. Speed command signal Ss decreases since the following holds: actual speed signal Sr>target speed signal St. Accordingly, the rotational frequency of motor 2 is decreased to the rotational frequency caused by external force.

Part (c) of FIG. 4 is a timing diagram showing startup from an idling state in which motor drive device 1A runs in reverse rotation at a high speed, i.e., the case where the idling state of motor drive device 1A at startup is a state in which motor drive device 1A runs in reverse rotation and actual speed signal Sr is higher than input speed signal Si. Before startup before time t0, part (c) of FIG. 4 is the same as part (b) of FIG. 2. When a rising edge of input speed signal Si occurs and motor drive device 1A starts at time t0, the following holds: actual speed signal Sr>input speed signal Si. Accordingly, target speed signal St is tentative speed signal Sz higher than actual speed signal Sr. Speed comparison result Cs output by speed comparator 11 indicates L level since the following holds: target speed signal St>actual speed signal Sr. Speed command signal Ss output by speed command generator 12 increases, and thus outputter 13 is driven to increase the rotational frequency of motor 2 in the forward rotation direction. To be more specific, when in the reverse rotation state, the rotational frequency begins to decrease, and the output of differentiator 105 is changed to indicate L level.

When the decreased actual speed signal Sr falls below input speed signal Si at time t1, the output of comparator circuit 100 is inverted to indicate H level, and thus the switching signal output by OR circuit 103A is changed to indicate H level and the output of edge detection circuit 101A is also changed to indicate H level in target speed generator 10A. Accordingly, switching circuit 104 changes a signal to be output as target speed signal St to input speed signal Si. The rotational frequency of motor 2 that decreases due to the reverse rotation becomes zero after a while at time t2. Then, the rotation is changed to forward rotation and the rotational frequency begins to increase. Accordingly, the output of differentiator 105 is changed to indicate H level.

When actual speed signal Sr reaches target speed signal St at time t3, speed comparison result Cs indicates H level and the output of comparator circuit 100 is changed to indicate L level. Thereafter, the rotational frequency of motor 2 is maintained approximately at the target rotational frequency by the same operation described with reference to part (a) of FIG. 4. Although the output of comparator circuit 100 and the output of differentiator 105 are unstable, the output of edge detection circuit 101A, namely the switching signal, is fixed to indicate H level, and switching circuit 104 maintains input speed signal Si as target speed signal St.

As has been described above, since the target rotational frequency is temporarily set greater than the actual rotational frequency, motor drive device 1A according to Embodiment 2 can forcibly drive motor 2 in the forward rotation direction to start motor 2 even in a state in which motor 2 is running in the reverse rotation at rotational frequency greater than or equal to the target rotational frequency due to external force, etc., before the startup. Moreover, after the target rotational frequency is temporarily increased, the actual rotational frequency increases when the motor drive device is running in the forward rotation, whereas the actual rotational frequency decreases when the motor drive device is running in the reverse direction. With this, the rotational direction of motor 2 can be determined. When the rotational frequency is high in the forward rotation, the signal to be output as target speed signal St is changed back to input speed signal Si at the time point at which the rotation is determined to be the forward rotation. Accordingly, an increase in the rotational frequency can be inhibited.

### Embodiment 3

In Embodiments 1 and 2, the edge detection circuit is used to limit a change in the target rotational frequency to happen at startup so that the change in the target rotational frequency will not happen during steady-state operation after the startup. However, in order to prevent malfunction after the startup, a given time from the startup may be set as a startup time, and setting and changing of the target rotational frequency may be limited within this startup time. Stated differently, fixing target speed signal St to input speed signal Si after the startup time eliminates the need for the edge detection circuit or a latch circuit of some kind, and stabilizes steady-state operation. A motor drive device according to Embodiment 3 has a function of stabilizing steady-state operation without requiring the edge detection circuit or a latch circuit of some kind by providing a startup time.

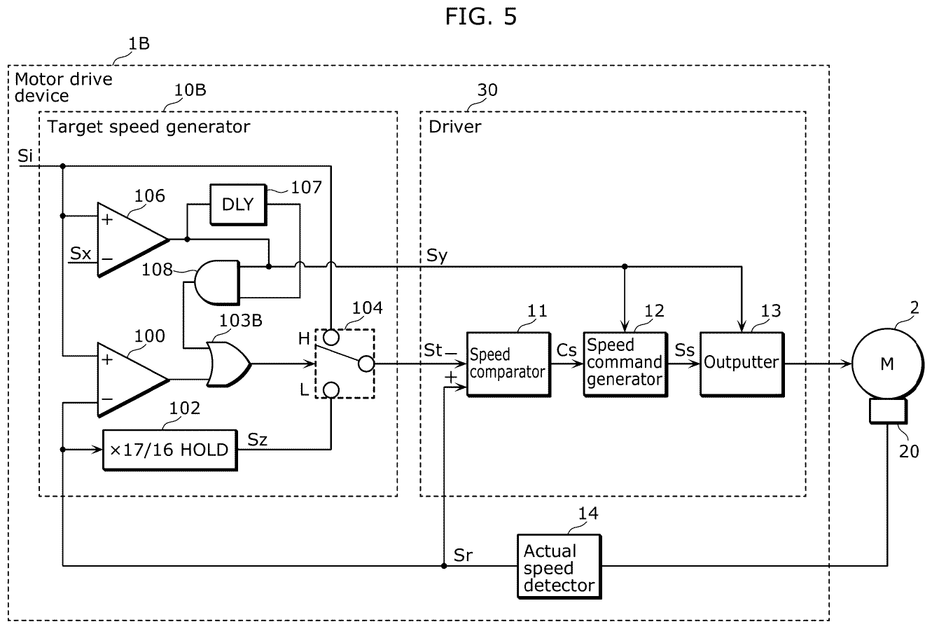

FIG. 5 illustrates a circuit configuration of motor drive device 1B according to Embodiment 3. In FIG. 5, the same numbers are given to the elements same as those included in motor drive device 1 shown in FIG. 1. A difference from FIG. 1 is target speed generator 10B having a modified internal configuration. Specifically, (i) feedback of speed comparison result Cs from speed comparator 11 is not provided, (ii) edge detection circuit 101 is removed, and (iii) the following elements are provided: comparator circuit 106 that compares input speed signal Si and given value Sx; delay circuit 107 that delays an output of comparator circuit 106; AND circuit 108 that outputs a logical product of an output of comparator circuit 106 and an output of delay circuit 107; and, instead of OR circuit 103, OR circuit 103B that receives, as inputs, an output from comparator circuit 100 and an output from AND circuit 108 to output a switching signal to switching circuit 104. Moreover, an output of comparator circuit 106 is output from target speed generator 10B as operation signal Sy, and is input to speed command generator 12 and outputter 13 as an enable signal.

Comparator circuit 106 outputs H level when input speed signal Si is greater than or equal to given value Sx. Given value Sx is set lower than the normal level of input speed signal Si that occurs after the start of operation, and a delay time of delay circuit 107 is set to correspond with the startup time of motor 2. In other words, a time period during which operation signal Sy, that is the output of comparator circuit 106, is indicating H level is an operation time period of motor 2, and a time period during which the output of AND circuit 108 is indicating L level is a standstill and startup time of motor 2.

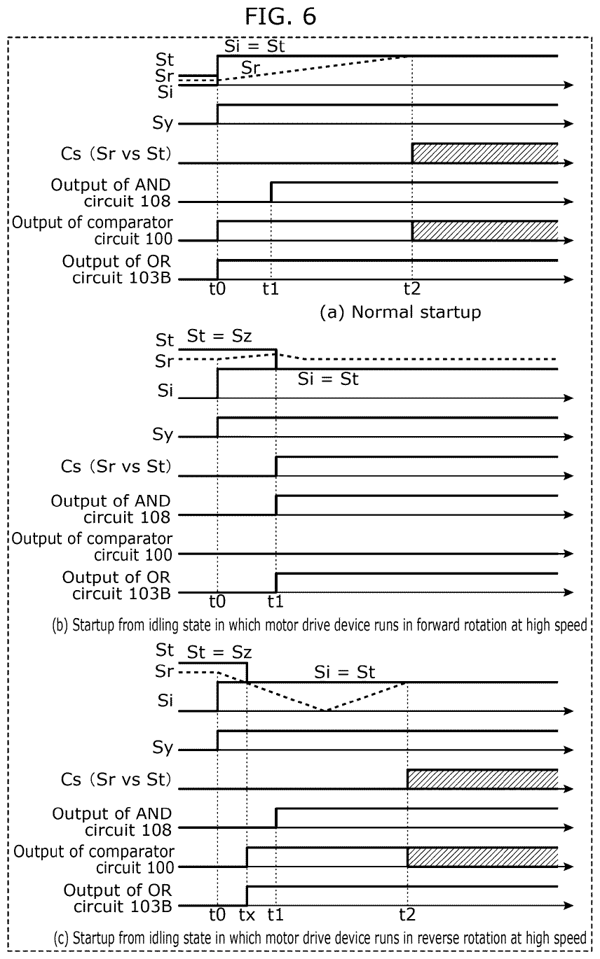

Operation at startup of motor drive device 1B according to Embodiment 3 which is configured as described above will be further described in detail with reference to FIG. 6. FIG. 6 illustrates a timing diagram (part (a) of FIG. 6) showing normal startup of motor drive device 1B according to Embodiment 3, a timing diagram (part (b) of FIG. 6) showing startup from an idling state in which motor drive device 1B runs in forward rotation at a high speed, and a timing diagram (part (c) of FIG. 6) showing startup from an idling state in which motor drive device 1B runs in reverse rotation at a high speed. FIG. 6 shows signal waveforms in main elements of motor drive device 1B.

Part (a) of FIG. 6 is a timing diagram showing normal startup, i.e., the case where actual speed signal Sr is lower than input speed signal Si regardless of the rotation direction in an idling state of motor drive device 1B at startup. Before startup before time t0, input speed signal Si=0, denoting the standby state, and the output of comparator circuit 100 is set to indicate L level. Moreover, since operation signal Sy that is the output of comparator circuit 106 also indicates L level, the output of OR circuit 103B indicates L level. Accordingly, switching circuit 104 selects and outputs tentative speed signal Sz as target speed signal St. Here, motor 2 is running in forward rotation at idle due to a slight external force, and the following holds: target speed signal St>actual speed signal Sr>input speed signal Si=0. Since operation signal Sy indicates L level, speed command generator 12 and outputter 13 are also in the standby state, and thus a signal for driving motor 2 is not output.

When a rising edge of input speed signal Si occurs at time t0 and motor drive device 1B starts, the following holds: input speed signal Si>actual speed signal Sr. Accordingly, the output of comparator circuit 100 is changed to indicate H level. The output of OR circuit 103B is also changed to indicate H level, and thus switching circuit 104 selects and outputs input speed signal Si as target speed signal St. Since operation signal Sy is changed to indicate H level, speed command generator 12 and outputter 13 start operation, and speed comparison result Cs output by speed comparator 11 indicating L level, which indicates target speed signal St>actual speed signal Sr, causes the rotational frequency of motor 2 to begin to increase in the forward rotation direction (when in the reverse rotation, the rotational frequency increases after a temporary stop).

After the output of AND circuit 108 is changed to indicate H level at time t1 and actual speed signal Sr reaches target speed signal St at time t2, the rotational frequency of motor 2 is maintained approximately at the target rotational frequency. Since the rotational frequency of motor 2 slightly exceeds or falls below the target rotational frequency, the output of comparator circuit 100 and speed comparison result Cs are, in a strict sense, unstable. However, since the output of AND circuit 108 indicates H level, the switching signal is also fixed to indicate H level. Accordingly, switching circuit 104 maintains input speed signal Si as target speed signal St.

Part (b) of FIG. 6 is a timing diagram showing startup from an idling state in which motor drive device 1B runs in forward rotation at a high speed, i.e., the case where the idling state of motor drive device 1B at startup is a state in which motor drive device 1B runs in forward rotation and actual speed signal Sr is higher than input speed signal Si. Except that the level of actual speed signal Sr is high, part (b) of FIG. 6 is the same as part (a) of FIG. 6 showing the normal startup before startup before time t0. When a rising edge of input speed signal Si occurs and motor drive device 1B starts at time t0, the following holds: actual speed signal Sr>input speed signal Si. Accordingly, the output of comparator circuit 100 indicates L level. Since the output of AND circuit 108 also indicates L level, the switching signal output by OR circuit 103B indicates L level. Accordingly, switching circuit 104 selects and outputs tentative speed signal Sz as target speed signal St. This tentative speed signal Sz has a value increased by 6.25% of actual speed signal Sr at the startup, and the following holds: target speed signal St>actual speed signal Sr. Accordingly, speed comparison result Cs output by speed comparator 11 indicates L level. Speed command signal Ss output by speed command generator 12 increases, and thus outputter 13 is driven to increase the rotational frequency of motor 2 in the forward rotation direction. Accordingly, the rotational frequency of motor 2 in the forward rotation direction is further increased.

When the output of AND circuit 108 is changed to H level at time t1, the switching signal is fixed at H level and target speed signal St is fixed to input speed signal Si. Speed command signal Ss decreases since the following holds: actual speed signal Sr>target speed signal St. Consequently, the rotational frequency of motor 2 is decreased to the rotational frequency caused by external force.

Part (c) of FIG. 6 is a timing diagram showing startup from an idling state in which motor drive device 1B runs in reverse rotation at a high speed, i.e., the case where the idling state of motor drive device 1B at startup is a state in which motor drive device 1B runs in reverse rotation and actual speed signal Sr is higher than input speed signal Si. Before startup before time t0, part (c) of FIG. 6 is the same as part (b) of FIG. 6. When a rising edge of input speed signal Si occurs and motor drive device 1B starts at time t0, the following holds: actual speed signal Sr>input speed signal Si. Accordingly, target speed signal St is tentative speed signal Sz higher than actual speed signal at the startup. Speed comparison result Cs output by speed comparator 11 indicates L level since the following holds: target speed signal St>actual speed signal Sr. Since speed command signal Ss output by speed command generator 12 increases, outputter 13 is driven to increase the rotational frequency of motor 2 in the forward rotation direction. To be more specific, since motor 2 is in the reverse rotation state, the rotational frequency begins to decrease. When the decreased actual speed signal Sr falls below input speed signal Si, the output of comparator circuit 100 is inverted to indicate H level in target speed generator 10B. Accordingly, the switching signal output by OR circuit 103B is changed to indicate H level, and thus switching circuit 104 changes a signal to be output as target speed signal St to input speed signal Si. Time t1 at which the output of AND circuit 108 is changed to indicate H level may be set after the foregoing. The rotational frequency of motor 2 that decreases due to the reverse rotation becomes zero after a while. Then, the rotation is changed to the forward rotation and the rotational frequency begins to increase.

When actual speed signal Sr reaches target speed signal St at time t2, speed comparison result Cs indicates H level and the output of comparator circuit 100 is changed to indicate L level. Thereafter, the rotational frequency of motor 2 is maintained approximately at the target rotational frequency by the same operation described with reference to part (a) of FIG. 6. Although the output of comparator circuit 100 and speed comparison result Cs are unstable, the output of AND circuit 108 is fixed to indicate H level. Accordingly, switching circuit 104 maintains input speed signal Si as target speed signal St.

As has been described above, since the target rotational frequency is temporarily set greater than the actual rotational frequency, motor drive device 1B according to Embodiment 3 can forcibly drive motor 2 in the forward rotation direction to start motor 2 even in a state in which motor 2 is running in the reverse rotation at rotational frequency greater than or equal to the target rotational frequency due to external force, etc., before the startup. Moreover, an appropriately set startup time allows target speed signal St to be fixed to input speed signal Si during the operation time after a time period from the startup to the startup time. Accordingly, the need for the edge detection circuit or a latch circuit of some kind is eliminated, and the steady-state operation can be stabilized.

### [Motor Drive Method]

The motor drive device (particularly the target speed generator and the driver) according to the above-described Embodiments 1 to 3 can be realized not only as a piece of hardware using a dedicated electric circuit, but as a piece of software using a microcomputer or the like including a memory that stores programs and the like, a processor that executes the programs, and an input/output circuit (including an A/D converter, a D/A converter, and a digital input/output circuit). In order to clarify the foregoing point, operation to be performed by the motor drive device according to the above-described Embodiments 1 to 3, namely a motor drive method, will be described.

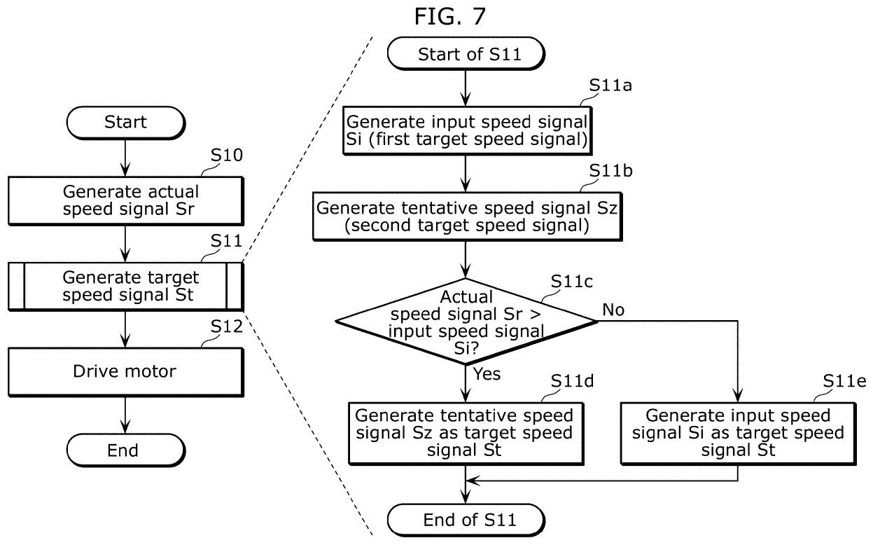

FIG. 7 is a flowchart illustrating operation performed by the motor drive devices (i.e., a motor drive method) according to Embodiments 1 to 3. Hereinafter, the operation will be described based on motor drive device 1 according to Embodiment 1 for convenience of describing the operation; however, the operation described below also applies to motor drive device 1A according to Embodiment 2 and motor drive device 1B according to Embodiment 3.

When motor drive device 1 is started, actual speed detector 14 generates actual speed signal Sr indicating the actual speed of motor 2 (actual speed detection step S10). Next, target speed generator 10 generates target speed signal St indicating a target speed of motor 2 (target speed generation step S11). Lastly, driver 30 drives motor 2 such that the actual speed indicated by actual speed signal Sr approaches the target speed indicated by target speed signal St (drive step S12).

Here, in target speed generation step S11, target speed generator 10 generates, by externally obtaining an input command, input speed signal Si that is one example of a first target speed signal indicating a speed based on the input command (S11a) and generates, by tentative speed setting circuit 102, tentative speed signal Sz that is one example of a second target speed signal indicating a speed higher than the actual speed at the startup of motor drive device 1 (S11b). Target speed generator 10 then determines, using comparator circuit 100, etc., whether the actual speed indicated by actual speed signal Sr at the startup of motor drive device 1 is higher than the speed indicated by input speed signal Si (S11c). When the actual speed is higher than the speed indicated by input speed signal Si (Yes in S11c), target speed generator 10 outputs tentative speed signal Sz as target speed signal St (S11d). Conversely, when the actual speed is not higher than the speed indicated by input speed signal Si (No in S11c), target speed generator 10 outputs input speed signal Si as target speed signal St (S11e).

Since the target rotational frequency is temporarily set greater than the actual rotational frequency, the motor drive method as has been described above can forcibly drive motor 2 in the forward rotation direction to start motor 2 even in a state in which motor 2 is running in the reverse rotation at rotational frequency greater than or equal to the target rotational frequency due to external force, etc., before the startup.

As has been described above, motor drive device 1, etc. according to the present disclosure includes: actual speed detector 14 that generates actual speed signal Sr indicating the actual speed of motor 2; target speed generator 10 or the like that generates target speed signal St indicating a target speed of motor 2; and driver 30 that drives motor 2 to cause the actual speed indicated by actual speed signal Sr to approach the target speed indicated by target speed signal St. Target speed generator 10 or the like (i) generates input speed signal Si that is one example of a first target speed signal indicating a speed based on an input command and tentative speed signal Sz that is a second target speed signal indicating a speed higher than the actual speed at startup of motor drive device 1, and (ii) when the actual speed indicated by actual speed signal Sr at the startup of motor drive device 1 is higher than the speed indicated by input speed signal Si, outputs tentative speed signal Sz as target speed signal St.

According to the above, when the actual speed indicated by actual speed signal Sr at startup of motor drive device 1, etc., is higher than the speed indicated by input speed signal Si, tentative speed signal Sz is output as target speed signal St indicating a speed higher than the actual speed at the startup of motor drive device 1, etc. As a result, motor 2 can be forcibly driven in the forward rotation direction to be started even in a state in which motor 2 is running in the reverse rotation at rotational frequency greater than or equal to the target rotational frequency due to external force, etc., before the startup, since the target rotational frequency is temporarily set greater than the actual rotational frequency. Therefore, it is possible to realize a motor drive device that can start a motor with a simple configuration.

Here, when the actual speed indicated by actual speed signal Sr reaches the speed indicated by tentative speed signal Sz while target speed generator 10 is outputting tentative speed signal Sz as target speed signal St, target speed generator 10 outputs input speed signal Si as target speed signal St. According to the above, after the actual speed has reached the speed indicated by tentative speed signal Sz, normal drive control is performed with the speed indicated by input speed signal Si as the target speed.

Moreover, when the actual speed indicated by actual speed signal Sr falls below the speed indicated by input speed signal Si while target speed generator 10 is outputting tentative speed signal Sz as target speed signal St, target speed generator 10 outputs input speed signal Si as target speed signal St. According to the above, input speed signal Si is output as target speed signal St when the actual speed falls below the speed indicated by input speed signal Si in a state in which motor 2 is running in the reverse rotation at rotational frequency greater than the target rotational frequency due to external force, etc., before the startup. Thereafter, normal drive control is performed with the speed indicated by input speed signal Si as the target speed.

In addition, in Embodiment 2, target speed generator 10A includes differentiator 105 that detects an increase and a decrease in the actual speed indicated by actual speed signal Sr. When differentiator 105 detects an increase in the actual speed while target speed generator 10A is outputting tentative speed signal Sz as target speed signal St, target speed generator 10A outputs input speed signal Si as target speed signal St. According to the above, the forward rotation and reverse rotation of motor 2 can be readily detected with a simple circuit. Moreover, motor 2 can be forcibly driven in the forward rotation direction to be started even in a state in which motor 2 is running in the forward rotation at rotational frequency greater than or equal to the target rotational frequency due to external force, etc., before the startup, since the target rotational frequency is temporarily set greater than the actual rotational frequency.

Moreover, in Embodiment 2, when differentiator 105 detects a decrease in the actual speed while target speed generator 10A is outputting tentative speed signal Sz as target speed signal St, target speed generator 10A determines that motor 2 is running in reverse rotation. According to the above, the forward rotation and reverse rotation of motor 2 can be readily detected with a simple circuit. Accordingly, motor 2 can be forcibly driven in the forward rotation direction to be started even in a state in which motor 2 is running in the reverse rotation at rotational frequency greater than or equal to the target rotational frequency due to external force, etc., before the startup.

In addition, in Embodiment 3, at and after a time point at which a given time period has elapsed from an occurrence of a rising edge of input speed signal Si, target speed generator 10B outputs input speed signal Si as target speed signal St. According to the above, target speed signal St is fixed to input speed signal Si during the operation time after a time point at which a given time period from the startup has elapsed. Accordingly, the steady-state operation can be stabilized without the need for the edge detection circuit according to Embodiment 1, etc. or a latch circuit of some kind.

Moreover, a motor drive method used by motor drive device 1 or the like. The motor drive method includes: actual speed generation step S10 of generating actual speed signal Sr indicating an actual speed of motor 2; target speed generation step S11 of generating target speed signal St indicating a target speed of motor 2; and drive step S12 of driving motor 2 to cause the actual speed indicated by actual speed signal Sr to approach the target speed indicated by target speed signal St. In target speed generation step S11, (i) input speed signal Si that is one example of a first target speed signal indicating a speed based on an input command and tentative speed signal Sz that is one example of a second target speed signal indicating a speed higher than the actual speed at startup of motor drive device 1 are generated (S11a and S11b), and (ii) when the actual speed indicated by actual speed signal Sr at the startup of motor drive device 1 is higher than the speed indicated by input speed signal Si (Yes in S11c), tentative speed signal Sz is output as target speed signal St (S11d).

According to the above, when the actual speed indicated by actual speed signal Sr at startup of motor drive device 1, etc., is higher than the speed indicated by input speed signal Si, tentative speed signal Sz is output as target speed signal St indicating a speed higher than the actual speed at the startup of motor drive device 1, etc. As a result, motor 2 can be forcibly driven in the forward rotation direction to be started even in a state in which motor 2 is running in the reverse rotation at rotational frequency greater than or equal to the target rotational frequency due to external force, etc., before the startup, since the target rotational frequency is temporarily set greater than the actual rotational frequency. Therefore, it is possible to implement a motor drive method that can start a motor with a simple configuration.

Note that the motor drive method according to the present disclosure can also be implemented as a program that causes a computer to execute actual speed detection step S10, target speed generation step S11, and drive step S12 included in the motor drive method or as a computer-readable recording medium such as a DVD on which the forgoing program is recorded.

Hereinbefore, the motor drive device and the motor drive method according to the present disclosure have been described based on Embodiments 1 to 3, etc., but the present disclosure is not limited to these embodiments. The scope of the present disclosure may encompass embodiments as a result of making, to the embodiments, various modifications that may be conceived by those skilled in the art, and different embodiments achieved by combining some elements in the embodiments, as long as the resultant embodiments do not depart from the spirit of the present disclosure.

For example, in each of the above-described embodiments, the startup has been detected from a rising edge of an input speed signal using comparator circuit 100, but the present disclosure is not limited to this configuration. The rising edge may be detected using a configuration in which a start signal is, for example, separately received as an input from an external element that produces input command signals.

Moreover, in each of the above-described embodiments, a location detection signal produced by the hall element has been used to calculate the rotational frequency of motor 2, but the present disclosure is not limited to this configuration. As long as the rotational frequency can be detected or calculated, sensorless control not using a location sensor, such as a hole element, may be performed to detect or calculate the rotational frequency. For example, as location detection under sensorless control, a method of detecting zero crossings of a motor winding voltage has been known. In this method, the rotational frequency can be calculated by counting the number of zero crossings within a given time period.

In addition, in Embodiment 1, etc., a signal indicating 17/16 times the speed indicated by actual speed signal Sr has been used as tentative speed signal Sz, but tentative speed signal Sz is non-limiting. Tentative speed signal Sz is to be a signal indicating a speed greater than the speed indicated by actual speed signal Sr.

Moreover, in Embodiment 3, given value Sx input to one input terminal of comparator circuit 106 and a delay amount of delay circuit 107 may be fixed values or externally-adjustable variable values.

Furthermore, in each of the above-described embodiments, input speed signal Si has been determined by an input command signal externally input, but input speed signal Si may have, depending on the intended use of the motor drive device, a fixed value or a value determined by the motor drive device.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

As a motor drive device that can start a motor with a simple configuration, the motor drive device according to the present disclosure can be used as, for example, drive devices of fan motors and drive devices of motors that may run at idle due to external force such as the wind.

1. A motor drive device comprising:
an actual speed detector that generates an actual speed signal indicating an actual speed of a motor;
a target speed generator that generates a target speed signal indicating a target speed of the motor; and
a driver that drives the motor to cause the actual speed indicated by the actual speed signal to approach the target speed indicated by the target speed signal, wherein
the target speed generator (i) generates a first target speed signal indicating a speed based on an input command and a second target speed signal indicating a speed higher than the actual speed at startup of the motor drive device, and (ii) when the actual speed indicated by the actual speed signal at the startup of the motor drive device is higher than the speed indicated by the first target speed signal, outputs the second target speed signal as the target speed signal.

2. The motor drive device according to claim 1, wherein
when the actual speed indicated by the actual speed signal reaches the speed indicated by the second target speed signal while the target speed generator is outputting the second target speed signal as the target speed signal, the target speed generator outputs the first target speed signal as the target speed signal.

3. The motor drive device according to claim 1, wherein
when the actual speed indicated by the actual speed signal falls below the speed indicated by the first target speed signal while the target speed generator is outputting the second target speed signal as the target speed signal, the target speed generator outputs the first target speed signal as the target speed signal.

4. The motor drive device according to claim 1, wherein
the target speed generator includes a differentiator that detects an increase and a decrease in the actual speed indicated by the actual speed signal, and
when the differentiator detects an increase in the actual speed while the target speed generator is outputting the second target speed signal as the target speed signal, the target speed generator outputs the first target speed signal as the target speed signal.

5. The motor drive device according to claim 4, wherein
when the differentiator detects a decrease in the actual speed while the target speed generator is outputting the second target speed signal as the target speed signal, the target speed generator determines that the motor is running in reverse rotation.

6. The motor drive device according to claim 1, wherein
at and after a time point at which a given time period has elapsed from an occurrence of a rising edge of the first target speed signal, the target speed generator outputs the first target speed signal as the target speed signal.

7. A motor drive method used by a motor drive device, the motor drive method comprising:
generating an actual speed signal indicating an actual speed of a motor;
generating a target speed signal indicating a target speed of the motor; and
driving the motor to cause the actual speed indicated by the actual speed signal to approach the target speed indicated by the target speed signal, wherein
in the generating of the target speed signal, (i) a first target speed signal indicating a speed based on an input command and a second target speed signal indicating a speed higher than the actual speed at startup of the motor drive device are generated, and (ii) when the actual speed indicated by the actual speed signal at the startup of the motor drive device is higher than the speed indicated by the first target speed 10 signal, the second target speed signal is output as the target speed signal.
